(19) United States
(12) Patent Application Publication
(10) Pub. No.: US 2016/0273062 A1
(43) Pub. Date: Sep. 22, 2016

(54) METHOD FOR OPERATING AN ELECTRIC ARC FURNACE, AND ELECTRIC ARC FURNACE

(71) Applicant: PRIMETALS TECHNOLOGIES GERMANY GMBH, Erlangen (DE)

(72) Inventors: Manfred BALDAUF, Erlangen (DE); Martin HERGT, Nürnberg (DE); Thomas MATSCHULLAT, Eckental (DE)

(21) Appl. No.: 15/033,532

(22) PCT Filed: Oct. 23, 2014
(86) PCT No.: PCT/EP2014/072751

§ 371 Date: Apr. 29, 2016

(30) Foreign Application Priority Data
Oct. 31, 2013 (DE) 10 2013 222 158.4

(51) Int. Cl. C21C 5/52; C21C 7/072; H05B 7/18; H05B 7/06; F27D 11/10; F27B 14/06

(52) U.S. Cl. CPC C21C 5/5217; F27D 11/10; F27B 14/06; H05B 7/185; H05B 7/06; C21C 7/072; F27D 2019/0068

(57) ABSTRACT

A method for operating an electric arc furnace (10) which has at least one electrode (18) having a through-opening (32). An electric arc (20) is generated between the at least one electrode (18) and a material to be melted (16). A first additive is introduced into the through-opening (32) of the electrode (18) for causing an endothermic chemical reaction which is controlled such that the chemical reaction is caused in a predetermined region (34) of the at least one electrode (18), wherein the region faces the material to be melted (16).

### CROSS-REFERENCE TO RELATED APPLICATIONS

The present application is a 35 U.S.C. §§371 national phase conversion of PCT/EP2014/072751, filed Oct. 23, 2014, which claims priority of German Patent Application No. 102013222158.4, filed Oct. 31, 2013, the contents of which are incorporated by reference herein. The PCT International Application was published in the German language.

### TECHNICAL FIELD

The present invention relates to a method for operating an electric arc furnace. The present invention additionally relates to an electric arc furnace for melting a charge material.

### TECHNICAL BACKGROUND

In an arc furnace, in particular an electric arc furnace, an electric arc supplies electrical energy in the form of arc discharges to solid scrap metal and, in a subsequent phase, the arc supplies electrical energy to a molten bath via graphite electrodes. In the first phase, the solid scrap is heated and melted directly by the arc and/or indirectly by the radiation of the arc. In subsequent phases, the molten bath is brought to the desired target temperature by the energy of the arc. A high energy input to the scrap or molten metal is important in order to minimize the melting time to ensure high production capacities and to increase the energy efficiency of the process.

Usually a furnace transformer is used to transform a medium voltage into a low voltage and apply it to the electrodes. The gap between the electrodes and the scrap material or molten bath can be varied in order to strike the arc across a small gap and, by increasing the gap, to control electrical operating parameters such as the voltage and/or the current intensity during operation.

During operation of the electric arc furnace, the graphite electrodes are subject to high temperature gradients. At the top of the electrodes, the electrode temperature is of the order of the ambient or shop temperature, whereas at the bottom of the electrodes just above the molten bath is at approximately 3000 K. These high temperatures acting together with the arc result in increased electrode consumption in the ambient air. The graphite electrode consumption is 50% lateral oxidation. Otherwise the consumption is proportional to the square of the current intensity. This means that for operating conventional arc furnaces, it is attempted as far as possible to avoid high current intensities with simultaneously small arcs in order to minimize graphite losses.

Temperature gradients along the electrodes can also result in mechanical stresses which can cause fragments to flake off or, in extreme cases, electrode breakage. Electrode breakage would not only result in increased electrode consumption but also in production downtimes and carbon pick-up in the steel if the graphite electrode or fragments thereof fall into the molten bath. The energy input to the molten bath or scrap is nowadays controlled solely by the electrical parameters and the physical gap between the electrode and the metal.

WO 2013/064413 A1 discloses a method for operating an electric arc furnace wherein the arc can be controlled by the admixture of additives so that particular characteristics can be advantageously adjusted in the individual operating phases of the electric arc furnace. The conductivity in the arc and the radiated power can be increased or reduced depending on the type of additive introduced.

Increasing the conductivity in the arc, i.e. in the plasma, results in larger electrode gaps and therefore a reduction in the current fluctuations and so-called flicker. At the same time the radiated power is increased in magnitude and volume, so that the large-volume radiation of energy results in a rapid scrap heating process. The energy input can therefore be reduced in this phase. To increase conductivity in the arc, a metal or a metallic salt can be introduced into the plasma. On the other hand, reducing the conductivity of the plasma results in a small electrode gap and lower radiated powers and therefore also in lower radiation losses on the furnace walls. As a result, during liquid phase operation, electrical energy is very efficiently applied to the molten bath. To reduce the arc's conductivity, gases such as argon, nitrogen, methane, carbon dioxide or similar can be introduced into the plasma.

To introduce the gases into the arc, hollow graphite electrodes can be used, the upper ends of which have corresponding nipples for connecting gas feeds. Via these nipples, gas can be fed into the interior of the hollow electrode and from there into the arc which has its root at the lower end of the hollow electrode.

In the case of the conventional electric arc furnace for melting scrap material, such a method has so far not been used. In some ladle furnaces, on the other hand, the principle of introducing gas via hollow electrodes is well known. Here, however, mainly argon is injected in order to prevent carbon pick-up in the molten bath.

The electrodes are usually cooled on the exterior by the spraying or trickling-down of water. Following its introduction some 30 years ago, this measure had an enormous effect on graphite consumption. However, as the trickling-down water evaporates, the lower section of the electrode is not cooled. Moreover, the interior of the electrode receives no cooling at all. In this context, WO 2013/064413 A1 also describes supplying the arc with an additive which brings about a reaction which, because of its energy consumption, results in cooling of the electrode.

In addition, WO 03/037038 A2 describes an electrode for an electric arc furnace having a device for emitting a fluid in the direction of a metal bath. The fluid contains at least one heat-decomposable, carbon-rich combustible component. The component can be in particular a gaseous hydrocarbon, selected from the group methane, ethane, propane, butane and mixtures thereof. A cloud which shields the electrode tip can therefore be produced and the graphite surface of the electrode can be coated with a solid layer.

Moreover, EP 0 548 042 A1 describes a method for producing metal melts, in particular steel melts from scrap, in an electric arc furnace. Here organic substances are introduced through a central longitudinal recess in a graphite electrode. The organic substances introduced into the arc can be hydrocarbons in solid, liquid and/or gaseous form. The hydrocarbons can be decomposed there, cooling the electrode tip, and the decomposition products subsequently combusted.

### SUMMARY OF THE INVENTION

The object of the present invention is to operate an electric arc furnace of the type mentioned in the introduction in a more efficient manner.

This object is achieved by a method disclosed herein and by an arc furnace having the features disclosed herein.

In the inventive method for operating an arc furnace, wherein the arc furnace comprises at least one electrode having a through-hole, an electric arc is struck between the at least one electrode and a charge material to be melted. A first additive is introduced into the through-hole of the electrode, to cause an endothermic chemical reaction by the introduction of the first additive into the through-hole. The introduction of the first additive is controlled such that the endothermic chemical reaction is brought about in a predetermined region of the at least one electrode, particularly the region facing the charge material, wherein, for introducing the first additive, the position at which the first additive is introduced into the through-hole is varied.

The arc furnace can be implemented in particular as an electric arc furnace. The furnace comprises at least one electrode which is preferably made of graphite. At the electrode, a voltage can be provided by a furnace transformer, causing an arc to be struck between the electrode and the charge material to be melted. In particular, scrap steel can be used as the charge material. The at least one electrode is implemented as a hollow electrode. A first additive can be introduced into the interior of the electrode, i.e. into the through-hole thereof. The first additive introduced can be a solid material, an aerosol and/or a fluid. In particular, a gas is fed into the electrode hole as a first additive.

The first additive is selected primarily such that an endothermic chemical reaction is produced. The first additive can also be selected such that the chemical reaction only takes place from a particular temperature onwards. Energy is therefore required in the chemical reaction. This energy can be drawn from the heated electrode. As a result, the electrode releases thermal energy and is therefore cooled. Here the introduction of the first additive is controlled such that the endothermic chemical takes place in a region of the electrode facing the molten bath. The region of the electrode that is heated during operation of the arc furnace can therefore be cooled. Mechanical stresses in the electrode and electrode consumption can therefore be reduced.

In addition, for introducing the first additive, the position at which the first additive is introduced into the through-hole is varied. For this purpose the electrode can have a plurality of orifices through which the first additive can be introduced into the through-hole. The region in which the endothermic chemical reaction takes place can therefore be influenced.

The introduction of the first additive can preferably be controlled such that the endothermic chemical reaction is produced at least in some areas inside the through-hole of the at least one electrode. The electrode can therefore be cooled particularly effectively from the through-hole.

In one embodiment, for introducing the first additive, the quantity of first additive introduced into the through-hole is controlled as a function of time. By influencing the quantity of first additive, the cooling of the electrode as a result of the endothermic chemical reaction can be controlled.

In another embodiment, for introducing the first additive, the flow rate of the first additive inside the through-hole is controlled. By controlling the flow rate of the first additive along the through-hole, the position at which the chemical reaction is produced inside through-hole can be adjusted.

The flow rate of the first additive is preferably controlled as a function of a product resulting from the endothermic chemical reaction. In the chemical reaction, the product can comprise more gas molecules than the educt. As a result, a volumetric expansion takes place. If the educt and product of the chemical reaction are known, the flow rate can be matched to the volumetric expansion.

In one embodiment, the at least one electrode is made of graphite and the chemical reaction is brought about using the first additive and the graphite as reactants. For example, carbon dioxide or water vapor can be introduced into the through-hole of the electrode as the first additive. Here the electrode material, i.e. the graphite or rather carbon, can be used as a reactant in the endothermic chemical reaction.

In another embodiment, a first gas and a second gas different from the first gas are introduced into the through-hole as the first additive. For example, methane can be introduced as the first gas and water vapor as the second gas. Alternatively, methane can be introduced as the first gas and carbon dioxide as the second gas. In addition, it is conceivable for the first additive to comprise carbon dioxide as the first gas and hydrogen as the second gas. The advantage of these first additives is that the electrode is not used as a reactant and the endothermic reaction for cooling the electrode can take place while conserving the electrode.

Preferably the quantity of first gas and/or the quantity of second gas introduced into the through-hole is controlled as a function of time. By controlling the proportions of the two gases, on the one hand the temperature above which the chemical reaction occurs, and, on the other hand, also the energy that is required for the chemical reaction can be influenced.

It is also advantageous if a second additive for reducing and/or increasing the field strength of the arc is additionally introduced into the through-hole. To reduce the field strength of the arc or rather of the plasma, a second additive which reduces the ionization energy in the arc can be introduced into the through-hole. For this purpose a metal or a metallic salt, for example, can be introduced as the second additive. In order to increase the field strength, a second additive which increases the ionization energy in the arc can be introduced. For this purpose a gas such as, for example, argon, nitrogen, methane, carbon dioxide or similar can be introduced into the plasma as the second additive. Thus, in addition to the cooling of the at least one electrode, the arc can be influenced in the different operating phases of the arc furnace.

In another embodiment, the external surface of the at least one electrode can be cooled using water. For example, water can be sprayed onto the electrode from the outside. Preferably the electrode can only be cooled by water in the lower region facing the charge material. Therefore, in addition to the chemical cooling inside the electrode, the electrode can also be externally cooled.

In addition, an arc furnace for melting a charge material is provided according to the invention, comprising at least one electrode having a through-hole, an electrical energy source for producing an arc between the at least one electrode and the charge material to be melted, a storage device containing a first additive, wherein the first additive can be introduced into the through-hole of the electrode and wherein an endothermic chemical reaction can be brought about by the introduction of the first additive into the through-hole, and a control device by which the introduction of the first additive into the through-hole can be controlled such that the endothermic chemical reaction can be produced in a predetermined region of the at least one electrode, said region facing the charge material, wherein, for introducing the first additive, the position at which the first additive is introduced into the through-hole can be varied.

The advantages and further developments described above in connection with the method according to the invention are correspondingly applicable to the arc furnace according to the invention.

### BRIEF DESCRIPTION OF THE DRAWINGS

The present invention will now be explained in greater detail with reference to the accompanying drawings in which:

FIG. 1 shows an arc furnace according to the prior art in a first operating phase;

FIG. 2 shows the arc furnace as shown in FIG. 1 in a second operating phase; and

FIG. 3 schematically illustrates an electrode of the invention for an arc furnace.

### DESCRIPTION OF EMBODIMENTS

The examples described in greater detail below constitute preferred embodiments of the present invention.

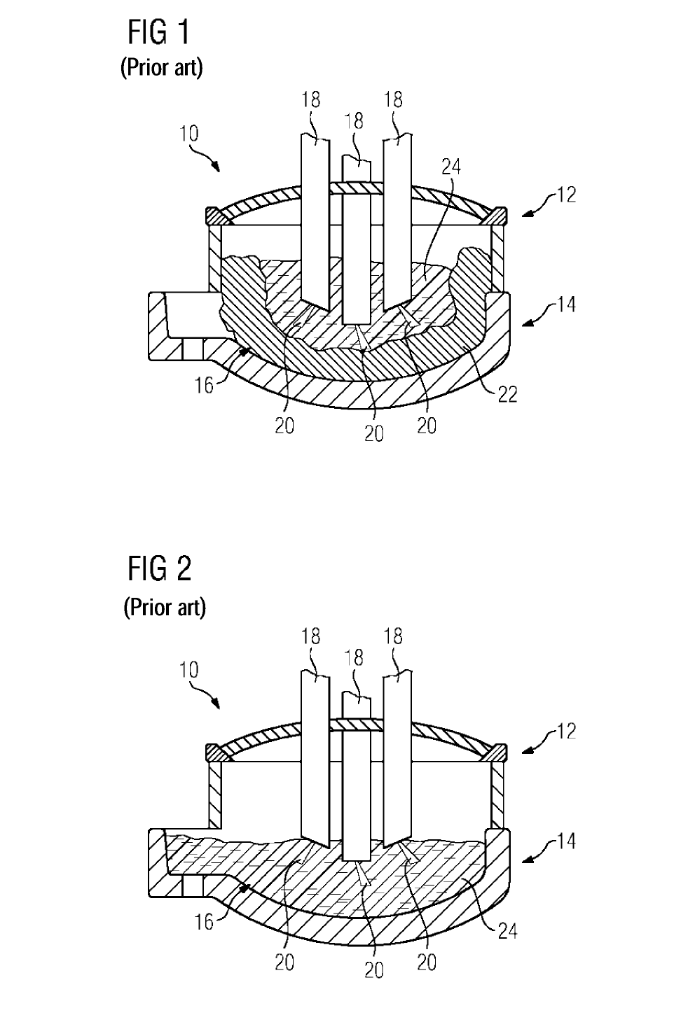

FIG. 1 shows a sectional side view of an arc furnace 10 according to the prior art. The arc furnace 10 is implemented as an electric arc furnace. The furnace 10 comprises an upper shell section 12 and a lower shell section 14 which can be moved relative to one another. The arc furnace 10 is used for melting a charge material 16, in particular scrap steel. The charge material 16 is placed in the lower shell section 14.

The arc furnace 10 additionally comprises at least one electrode 18. In this exemplary embodiment, the arc furnace 10 comprises three electrodes 18. The electrodes 18 are connected to a furnace transformer (not shown here) by which a voltage can be provided at the electrodes 18. At the electrodes 18, the voltage and/or the current intensity are selected such that an arc 20 is produced between the electrodes 18 and the charge material 16 to be melted. The gap between the electrodes 18 and the charge material 16 can be adjusted in order to strike the arc 20 when the gap is small and to influence electrical operating parameters during operation by increasing the gap.

In FIG. 1 the arc furnace 10 is shown in a first operating phase. Here the charge 16 is present as solid material 22. Energy is supplied to the solid material 22, i.e. the scrap, by the arcs 20. This causes the solid material 22 to melt, and the charge 16 is thus present as a molten bath 24.

FIG. 2 shows the arc furnace 10 as shown in FIG. 1 in a second operating phase. Here the charge material 16 is already completely a molten metal bath 24. By means of the energy which is applied to the molten bath 24 by the arcs 20, a predetermined target temperature of the molten bath 24 can be set.

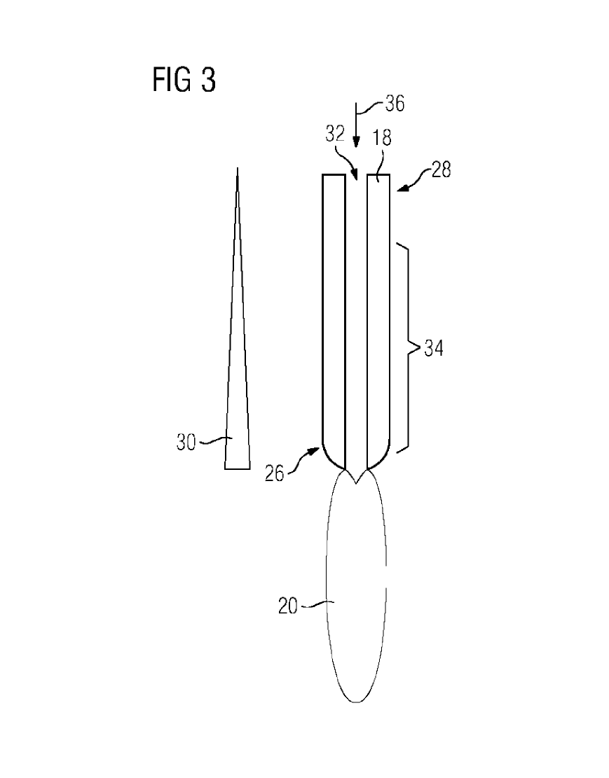

FIG. 3 schematically illustrates an electrode 18 of an arc furnace 10 in a sectional side view. During operation of the arc furnace 10, a temperature gradient is created along the electrode 18. This is caused by the electrode 18 being heated by the arc 20 in a lower region 26 facing the charge material 16 and the molten bath 24 being heated to a temperature of up to 3000 K. The arc 20 is also produced at the lower region 26 of the electrode 18. An upper region 28 of the electrode 18, which region is opposite the lower region 26, is at approximately ambient temperature, e.g. the ambient temperature in an industrial building. The temperature gradient is here illustrated by the arrow 30. The temperature gradient may produce mechanical stresses within the electrode 18 which can result in damage to the electrode 18. In addition, the high temperatures in the lower region 26 of the electrode 18 can cause consumption of the electrode 18.

The electrode 18 is here implemented as a hollow electrode. The electrode 18 is essentially hollow-cylindrically shaped. The electrode 18 has a through-hole 32 which extends from the upper region 28 to the lower region 26 of the electrode 18 along the longitudinal extent of the electrode 18. A first additive can be introduced into the through-hole 32. This is illustrated here by the arrow 36. For this purpose an appropriate fitting connected to a storage device or reservoir containing the first additive can be disposed on the electrode 18. In particular, a first gas is introduced into the through-hole 32 as an additive. Introducing the first additive into the through-hole 32 brings about an endothermic chemical reaction. Carbon dioxide or water vapor, for example, can be introduced as the first additive. Examples of such reactions are:

CO₂+C→2CO; ΔH_{R}=+172.6 kJ/mol (1)

C+H₂O→CO+H₂; ΔH_{R}=+131.4 kJ/mol (2)

C+2H₂O→CO₂+2H₂; ΔH_{R}=+90.2 kJ/mol (3)

In the reactions described in equations (1) to (3), the graphite electrode material, i.e. carbon, is used as a reactant. Equation (1) describes the so-called Boudouard reaction. ΔH_{R} describes the amount of energy required for the endothermic chemical reaction to proceed. This energy quantity ΔH_{R} is drawn from the environment. In particular, the energy is drawn from the electrode 18 in the form of heat energy.

A first and a second gas can be introduced into the hole 32 in the electrode 18 as an additive. Here the electrode 18 is not a participant in the chemical reaction. For example, methane and water vapor, methane and carbon dioxide or carbon dioxide and hydrogen can be introduced into the through-hole 32. Examples of such reactions are:

CH₄+H₂O→CO+3H₂; ΔH_{R}=+206.2 kJ/mol (4)

CH₄+CO₂→CO+2H₂; ΔH_{R}=+250.0 kJ/mol (5)

CO₂+H₂→CO+H₂O; ΔH_{R}=+41.2 kJ/mol (6)

It should be noted that the reactions described in equations (1) to (6) are equilibrium reactions which in particular only proceed at temperatures above 300 K. However, because of the thermodynamics at different temperature levels, the equilibria are shifted to the product side.

By the selection of reactants, both the energy quantity ΔH_{R} required for the reaction and the temperature at which the reaction takes place can be adjusted. As a temperature gradient is present along the electrode 18, by selecting the chemical reaction, the region 34 in which the chemical cooling effect sets in can be monitored and varied along the electrode axis. However, it should be noted that the above described equilibria may be kinetically inhibited at temperatures below 500° C. in the absence of catalysts and consequently proceed at a finite rate, so that the establishment of the thermodynamic equilibrium takes place in a delayed manner.

Such delays can in some cases be compensated by adjusting the flow rate of the first additive in the through-hole 32 of the electrode 18. Moreover, it should be noted that all the above described reactions with the exception of the reaction according to equation (6) proceed with an increase in volume. That is to say, on the educt side fewer gaseous molecules are involved per formula conversion than on the product side. For example, in the case of the reaction according to equation (4) four gas molecules are formed from two. This volume increase results in an increase in the flow rate, thereby enabling an additional cooling effect to be achieved in hot regions of the electrode 18.

In order to prevent the endothermic chemical reaction from proceeding too early, i.e. in the upper region 28 of the electrode 18, it is possible to provide a plurality of areas (not shown here) for feeding the first additive into the through-hole 32 and therefore utilize spatial degrees of freedom.

In addition to the first additive, a second additive can be introduced into the through-hole 32 of the electrode 18, thereby enabling the characteristics of the arc 20 to be influenced. For example, the field strength of the arc 20 can be influenced by the second additive. A combination of arc manipulation and chemical cooling of the electrodes 18 can be provided using a common equipment configuration. To control the introduction of the first and/or second additive, the voltage and/or current intensity of the arc can be monitored.

By introducing gases such as carbon monoxide, carbon dioxide, hydrogen, water vapor and/or methane which along with gases such as argon, nitrogen, oxygen and/or compressed air may be used anyway to influence the arc plasma, additional cooling of the electrodes 18 can be achieved. In addition, the quantity of the gases, the position at which the gases are introduced into the through-hole 32 and/or the flow rate thereof can be controlled in the individual operating phases of the arc furnace 10.

This offers the possibility of developing a control and automation concept in which, in a multidimensional parameter space, both the energy input to the charge material 16 by the arc 20 and the cooling of the electrodes 18 and the consumption of the electrodes 18 can be advantageously influenced by selecting the gas combinations, the mixing ratios thereof, the location where the gases are fed into the through-hole 32, the flow rate and/or the volumetric rate of flow of the gases.

1. A method for operating an arc furnace, wherein the arc furnace comprises at least one electrode which has a through-hole;
the method comprising:
producing an arc between the at least one electrode and a charge material to be melted;
introducing a first additive into the through-hole of the electrode, the additive selected for causing an endothermic chemical reaction by introducing the first additive into the through-hole;
controlling the introduction of the first additive to cause the endothermic chemical reaction to occur in a predetermined region of the at least one electrode, wherein the region faces the charge material to be melted; and
for introducing the first additive, varying positions in the through-hole at which the first additive is introduced into the through-hole.

2. The method as claimed in claim 1, further comprising controlling the introduction of the first additive such that the endothermic chemical reaction is caused at least in some of the positions inside the through-hole of the at least one electrode.

3. The method as claimed in claim 1, further comprising controlling a quantity of the first additive introduced into the through-hole as a function of time.

4. The method as claimed in claim 1, further comprising controlling a flow rate of the first additive inside the through-hole.

5. The method as claimed in claim 4, further comprising controlling the flow rate of the first additive as a function of a product resulting from the endothermic chemical reaction.

6. The method as claimed in claim 1, wherein the at least one electrode is comprised of graphite and the endothermic chemical reaction is brought about using the first additive and the graphite as reactants.

7. The method as claimed in claim 1, further comprising a first gas and a second gas different from the first gas are introduced into the through-hole as the first additive.

8. The method as claimed in claim 7, further comprising controlling the quantity of the first gas and/or the quantity of the second gas introduced into the through-hole as a function of time.

9. The method as claimed in claim 1, further comprising additionally introducing a second additive into the through-hole, the second additive being selected to reduce and/or increase a field strength of the arc.

10. The method as claimed in claim 1, further comprising water-cooling an external surface of the at least one electrode.

11. An arc furnace for melting a charge material in the furnace, the furnace comprising:
at least one electrode which has a through-hole,
an electrical energy source configured and located for producing an arc between the at least one electrode and the charge material to be melted,
a storage device in which a first additive is disposed, the storage device and first adoptive therein being positioned and configured such that the first additive can be introduced into the through-hole of the electrode and the introducing of the first additive into the through-hole causes an endothermic chemical reaction to be brought about,
the arc furnace comprises a control device configured and operable for controlling the introduction of the first additive such that the endothermic chemical reaction can be brought about in a predetermined region of the at least one electrode, the region of the at least one electrode facing the charge material to be melted, and
means for introducing the first additive such that the position at which the first additive is introduced into the through-hole can be varied.
